(19) United States
(12) Patent Application Publication
(10) Pub. No.: US 2024/0151165 A1
(43) Pub. Date: May 9, 2024

(54) Three Valve Cylinder Head Assembly

(71) Applicant: Ronald Phillips, Indianapolis, IN (US)

(72) Inventor: Ronald Phillips, Indianapolis, IN (US)

(21) Appl. No.: 17/980,158

(22) Filed: Nov. 3, 2022

(51) Int. Cl. F02F 1/42; F01L 1/053; F02F 1/24

(52) U.S. Cl. CPC F02F 1/4285; F01L 1/053; F02F 1/242; F01L 2250/04

(57) ABSTRACT

A three valve cylinder head assembly includes a cylinder head mountable to an internal combustion engine. The cylinder head has a combustion chamber which has a sloped roof such that the combustion chamber has a wedge shape. Additionally, the cylinder head has an exhaust port and a pair of intake ports. An exhaust valve is movably integrated into the cylinder head for opening and closing the exhaust port. A pair of intake valves is each movably integrated into the cylinder head for opening and closing a respective one of the intake ports. A cam shaft is rotatably disposed on the cylinder head and the cam shaft engages the exhaust valve and each of the intake valves. The cam shaft sequentially opens the exhaust valve and each of the intake valves as the cam shaft rotates for supporting operation of the internal combustion engine.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cylinder head devices and more particularly pertains to a new cylinder head device which has two intake valves and a single exhaust valve. The device includes a cam shaft with a pair of intake lobes and a single exhaust lobe. Each of the intake valves is opened by a respective intake lobe and the exhaust lobe is opened by the exhaust lobe. Additionally, the cylinder head has a wedge shaped combustion chamber to accommodate the pair of intake valves and the exhaust valve.

### (2) Description of Related Art Including Information Disclosed Under 37 CFR 1.97 and 1.98

The prior art relates to cylinder head devices including a porting and valve arrangement employing three valves with employ discrete air ports that merge into a common symmetrical outlet. The prior art discloses a cylinder head with a pair of inlet ports and an exhaust port each opening into a common face of the cylinder head. The prior art discloses a cylinder head device that includes a trio of intake valves oriented parallel to each other. The prior art discloses a three valve cylinder head device which includes a pair of intake ports located in opposing quadrants with respect to each other, a fuel injector aligned with a third quadrant and an exhaust valve aligned with a fourth quadrant. The prior art discloses a cylinder head device that includes a pair of intake valves and an exhaust valve each being disposed in a cylindrical combustion chamber.

### BRIEF SUMMARY OF THE INVENTION

An embodiment of the disclosure meets the needs presented above by generally comprising a cylinder head that is mountable to an internal combustion engine. The cylinder head has a combustion chamber which has a sloped roof such that the combustion chamber has a wedge shape. Additionally, the cylinder head has an exhaust port and a pair of intake ports. An exhaust valve is movably integrated into the cylinder head for opening and closing the exhaust port. A pair of intake valves is each movably integrated into the cylinder head for opening and closing a respective one of the intake ports. A cam shaft is rotatably disposed on the cylinder head and the cam shaft engages the exhaust valve and each of the intake valves. The cam shaft sequentially opens the exhaust valve and each of the intake valves as the cam shaft rotates for supporting operation of the internal combustion engine.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a three valve cylinder head assembly according to an embodiment of the disclosure.

FIG. 2 is a back phantom view of an embodiment of the disclosure.

FIG. 3 is a right side view of an embodiment of the disclosure.

FIG. 4 is a left side view of an embodiment of the disclosure.

FIG. 5 is a top view of an embodiment of the disclosure.

FIG. 6 is a bottom view of an embodiment of the disclosure.

FIG. 7 is a perspective detail view taken from circle 7 of FIG. 6 of an embodiment of the disclosure.

### DETAILED DESCRIPTION OF THE INVENTION

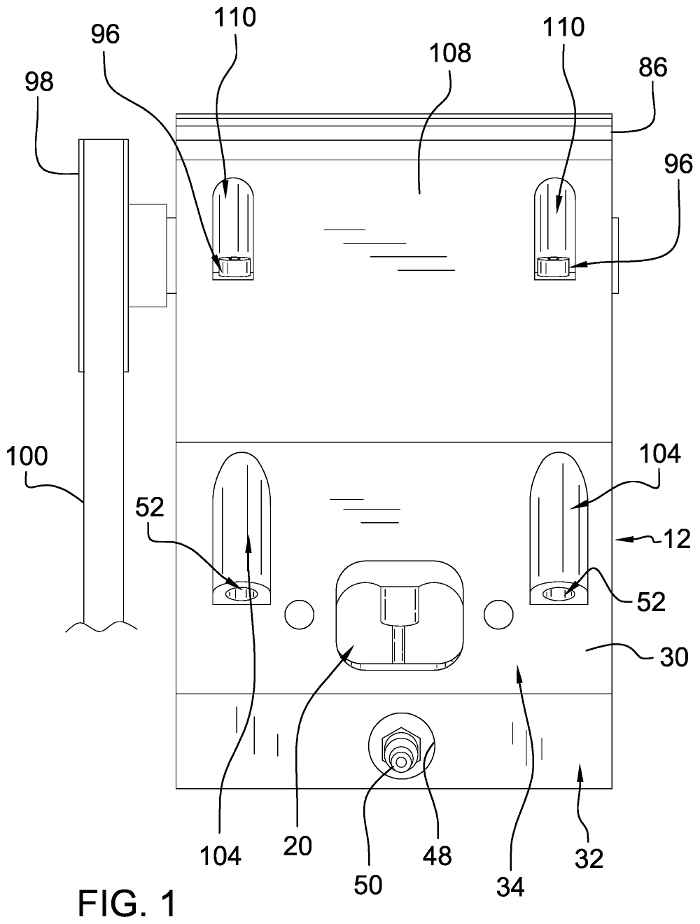

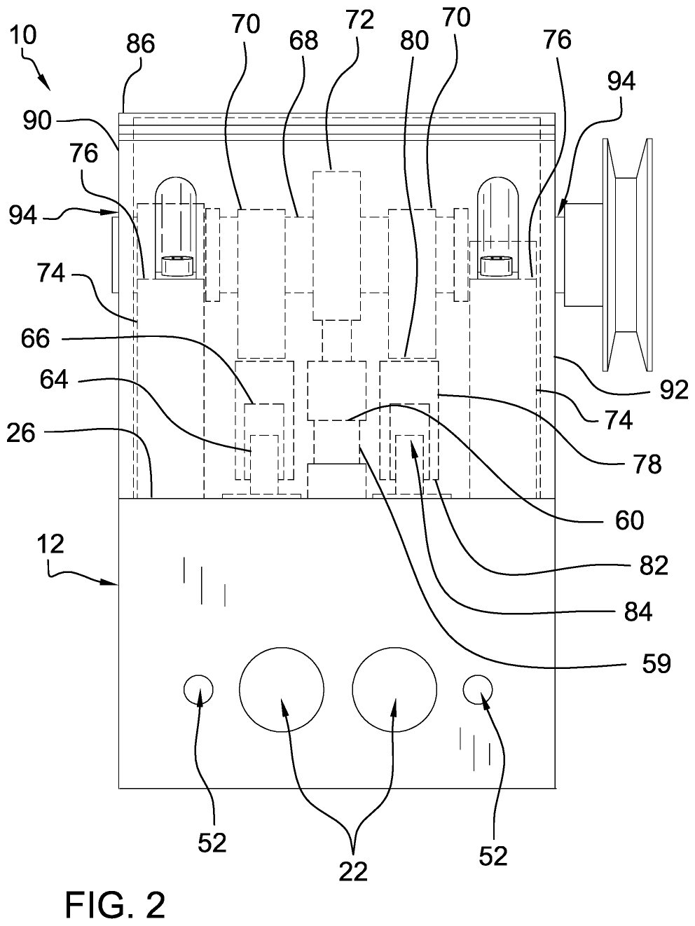

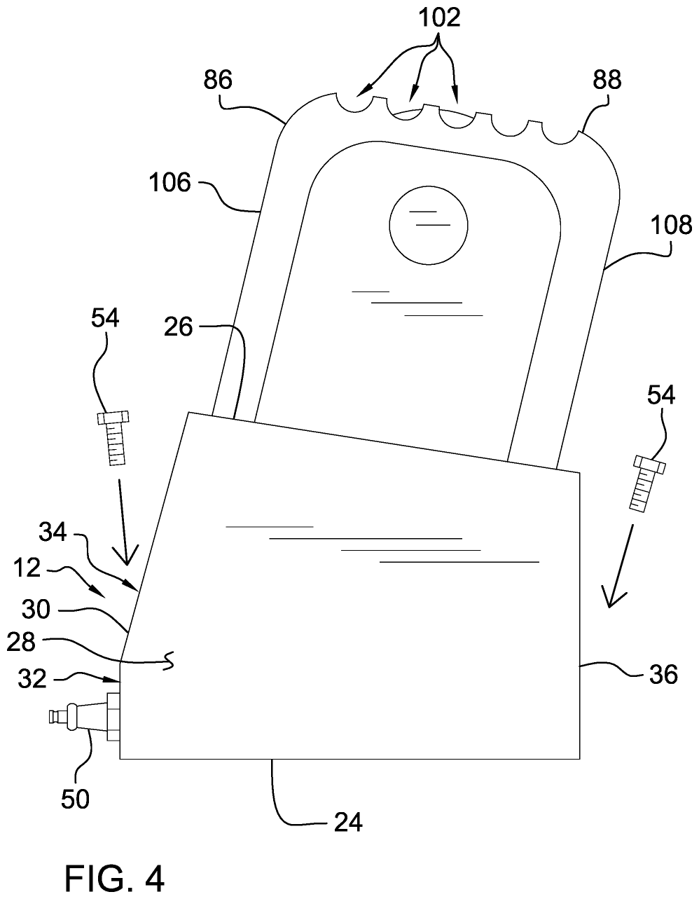

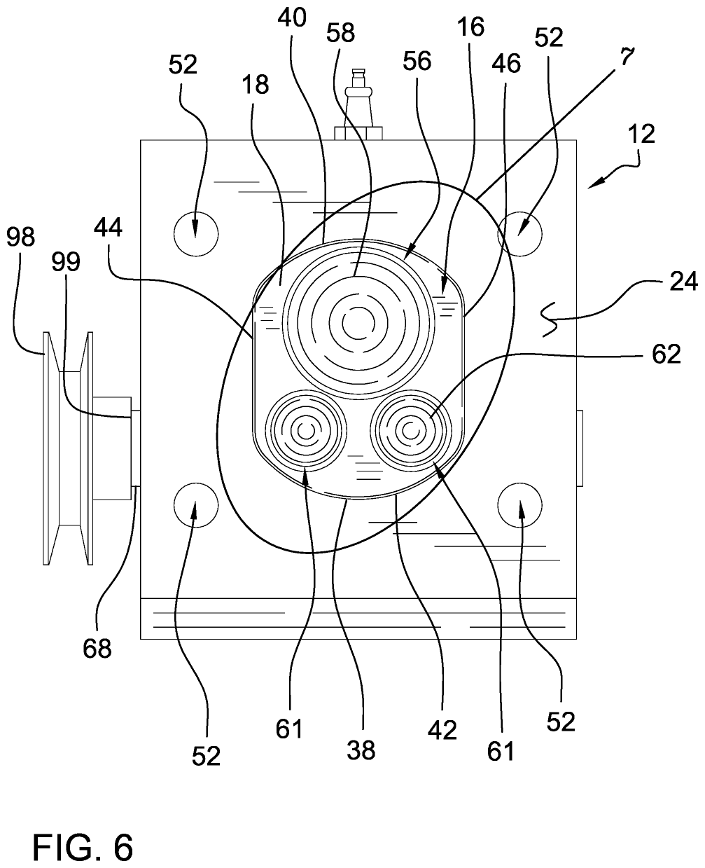

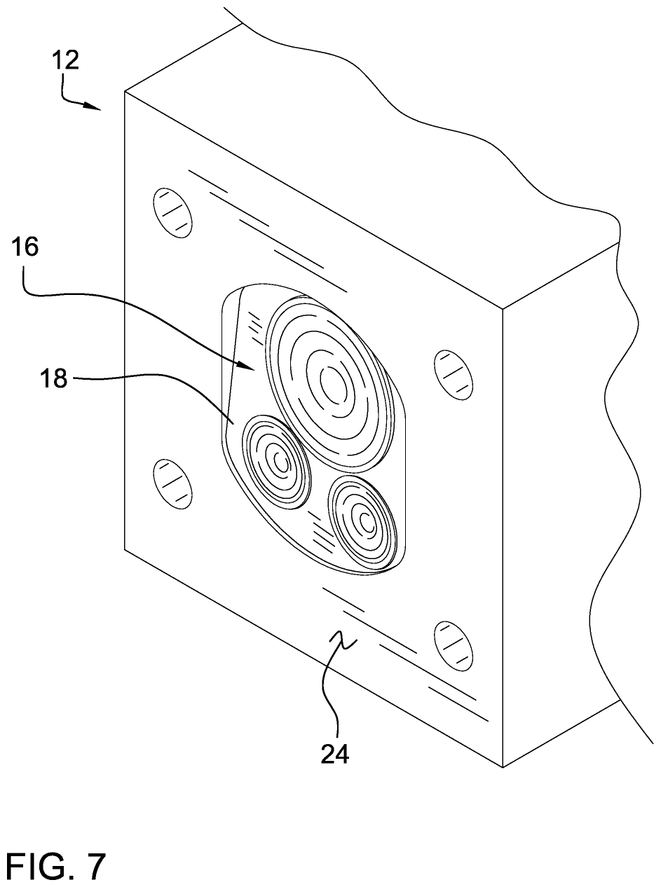

With reference now to the drawings, and in particular to FIGS. 1 through 7 thereof, a new cylinder head device embodying the principles and concepts of an embodiment of the disclosure and generally designated by the reference numeral 10 will be described.

As best illustrated in FIGS. 1 through 7, the three valve cylinder head assembly generally comprises a cylinder head 12 that is mountable to an internal combustion engine 14. The internal combustion engine 14 may be employed in motorized vehicle that is driven on public roadways, including but not being limited to a passenger vehicle or a cargo vehicle. The cylinder head 12 has a combustion chamber 16 which has a sloped roof 18 such that the combustion chamber 16 has a wedge shape and the cylinder head 12 has an exhaust port 20 and a pair of intake ports 22. The cylinder head 12 has a bottom surface 24, a top surface 26 and an outer surface 28 extending between the top surface 26 and the bottom surface 24 and a front side 30 of the outer surface 28 has a lower portion 32 forming an angle with an upper portion 34. The lower portion 32 intersects the bottom surface 24 and the upper portion 34 intersects the top surface 26.

The lower portion 32 lies on a plane that is perpendicularly oriented with a rear side 36 of the outer surface 28 and the upper portion 34 lies on a plane angling toward the rear side 36 between the lower portion 32 and the top surface 26. The front side 30 has a height that is greater than a height of the rear side 36 such that the top surface 26 lies on a plane angling downwardly between the front side 30 and the rear side 36. The combustion chamber 16 extends from the bottom surface 24 toward the top surface 26. Furthermore, the sloped roof 18 of the combustion chamber 16 slopes toward the top surface 26 along an axis which extends between the rear side 36 and the front side 30 of the outer surface 28 of the cylinder head 12. The combustion chamber 16 is centrally positioned on the bottom surface 24 and the combustion chamber 16 has a bounding edge 38 intersecting the bottom surface 24. The bounding edge 38 has a forward side 40, a rearward side 42, a first lateral side 44 and a second lateral side 46. The forward side 40 curves toward the front side 30 of the outer surface 28 of the cylinder head 12 and the rearward side 42 curves toward the rear side 36 of the outer surface 28 of the cylinder head 12.

Each of the intake ports 22 extends through the rear side 36 of the outer surface 28 and through the sloped roof 18 of the combustion chamber 16 to direct an air-fuel mixture into the combustion chamber 16. The exhaust port 20 extends through the front side 30 of the outer surface 28 and through the sloped roof 18 of the combustion chamber 16 to direct exhaust gases outwardly from the combustion chamber 16. The cylinder head 12 has a spark plug opening 48 which extends through the lower portion 32 of the front side of the outer surface 28 of the cylinder head 12 and into the combustion chamber 16 thereby facilitating a spark plug 50 to be threaded into the spark plug opening 48. Additionally, the cylinder head 12 has a plurality of bolt holes 52 each extending through the top surface 26 and the bottom surface 24 thereby facilitating head bolts 54 to be extended through each of the bolt holes 52 for attaching the cylinder head 12 to the internal combustion engine 14.

An exhaust valve 56 is movably integrated into the cylinder head 12 for opening and closing the exhaust port 20 and the exhaust valve 56 is positionable between an open position and a closed position. The exhaust valve 56 has a head 58 and a stem 59 and the stem 59 extends through the cylinder head 12 such that an end 60 of the stem 59 is spaced from the top surface 26 of the cylinder head 12. The head 58 of the exhaust valve 56 is aligned with the exhaust port 20 in the combustion chamber 16 and the head 58 of the exhaust valve 56 rests against the sloped roof 18 of the combustion chamber 16 when the exhaust valve 56 is in the closed position for closing the exhaust port 20. Conversely, the head 58 of the exhaust valve 56 is spaced from the sloped roof 18 when the exhaust valve 56 is in the open position for opening the exhaust port 20.

A pair of intake valves 61 is provided and each of the intake valves 61 is movably integrated into the cylinder head 12 for opening and closing a respective one of the intake ports 22. Each of the intake valves 61 is positionable between an open position and a closed position and each of the intake valves 61 has a head 62 and a stem 64. The stem 64 of each of the intake valves 61 extends through the cylinder head 12 such that an end 66 of the stem 64 of each of the intake valves 61 is spaced from the top surface 26 of the cylinder head 12. The head 62 of each of the intake valves 61 is aligned with a respective one of the intake ports 22 in the combustion chamber 16. The head 62 of each of the intake ports 22 rests against the sloped roof 18 of the combustion chamber 16 when the intake valves 61 are in the closed position for closing the intake ports 22. Conversely, the head 62 of each of the intake valves 61 is spaced from the sloped roof 18 when the intake valves 61 are in the open position for opening the intake ports 22.

A cam shaft 68 is rotatably disposed on the cylinder head 12 and the cam shaft 68 engages the exhaust valve 56 and each of the intake valves 61. The cam shaft 68 sequentially opens the exhaust valve 56 and each of the intake valves 61 as the cam shaft 68 rotates for supporting operation of the internal combustion engine 14. The cam shaft 68 has a pair of intake lobes 70 and an exhaust lobe 72 that is positioned between the intake lobes 70. Furthermore, the exhaust lobe 72 is offset a predetermined angle of rotation with the pair of intake lobes 70. A pair of risers 74 is each removably attached to the top surface 26 of the cylinder head 12. Each of the risers 74 has an upper end 76 which receives the cam shaft 68 such that the cam shaft 68 is spaced from the top surface 26.

A plurality of lifters 78 is provided and each of the lifters 78 has an upper end 80 and a lower end 82 and the lower end 82 of each of the lifters 78 has a well 84 extending toward the upper end 80. The end 66 of the stem 64 of the intake valves 61 and the end 60 of the stem 59 of the exhaust valve 56 is positioned in the well 84 in the lower end 82 of a respective one of the lifters 78. Additionally, the upper end 80 of each of the lifters 78 engages a respective one of the intake lobes 70 and the exhaust lobe 72 on the cam shaft 68. Each of the lifters 78 is individually urged downwardly when the respective intake lobe 70 and exhaust lobe 72 is directed downwardly when the cam shaft 68 rotates. Conversely, each of the lifters 78 is biased upwardly when the respective intake lobe 70 and exhaust lobe 72 is directed upwardly when the cam shaft 68 rotates. A plurality of rocker arms may be provided which extend between respective intake lobes 70 and exhaust lobe 72 and respective lifters 78. In this way the cam shaft 68 can be offset from the intake valves 61 and the exhaust valve 56 while still being in mechanical communication with the intake valves 61 and the exhaust valve 56. Each of the lifters 78 may comprise hydraulic lifters, roller lifters or any other type of conventional valve train lifter.

A valve cover 86 is removably attached to the cylinder head 12 such that the valve cover 86 surrounds the cam shaft 68 and the valve cover 86 has a topmost wall 88, a first lateral wall 90 and a second lateral wall 92. The valve cover 86 has a pair of camshaft openings 94 each extending through a respective one of the first lateral wall 90 and the second lateral wall 92 thereby facilitating the cam shaft 68 to be installed or removed through the camshaft openings 94. The valve cover 86 has a plurality of bolt openings 96 each extending through the valve cover 86 and each of the bolt openings 96 in the valve cover 86 is aligned with a respective one of the risers 74. In this way cam shaft 68 bolts can be extended through a respective one of the bolt openings in the valve cover 86 to attach the risers 74 to the cylinder head 12.

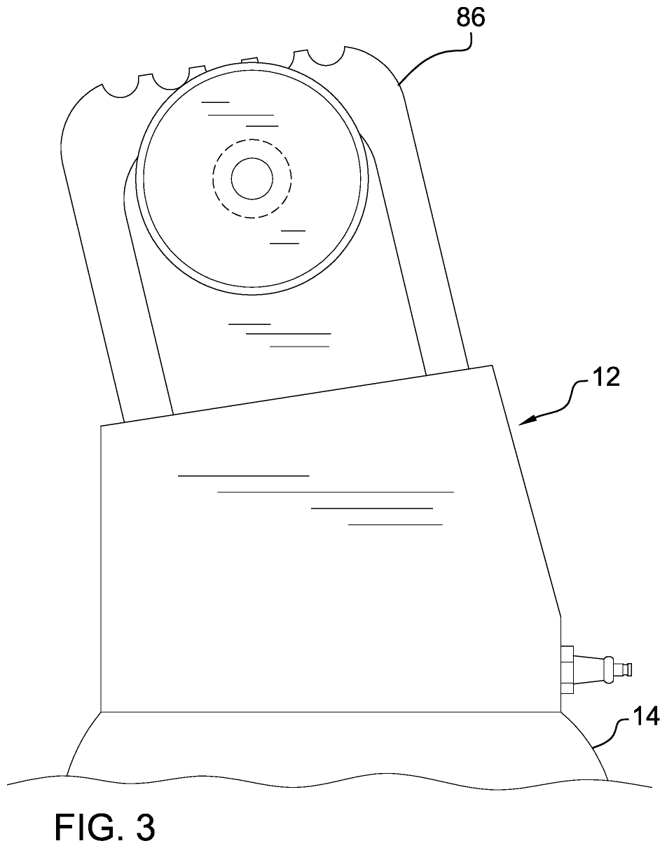

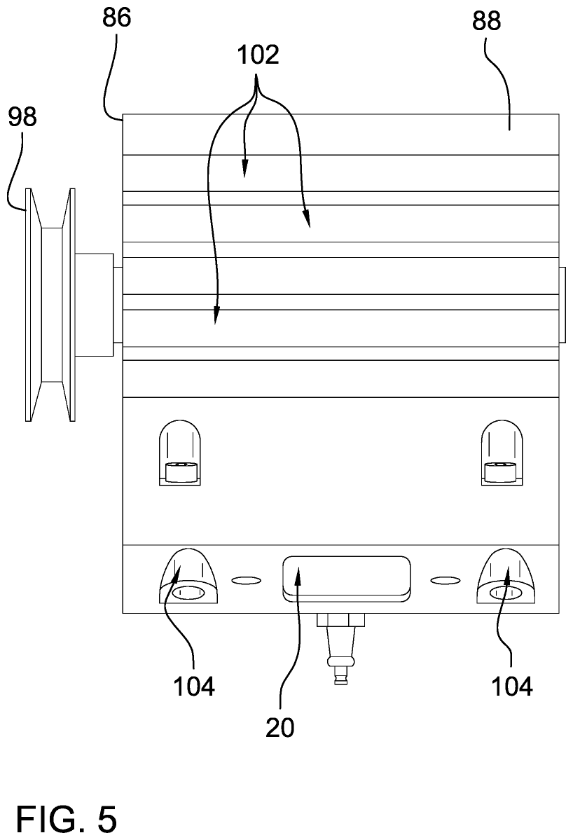

A pulley 98 is attached to a respective end 99 of the cam shaft 68 thereby facilitating a belt 100 to extend around the pulley 98 for rotating the cam shaft 68. The belt 100 may be driven by a crankshaft pulley or other source of rotational torque generated by the internal combustion engine 14. As is most clearly shown in FIGS. 3, 4 and 5, the topmost wall 88 of the valve cover 86 may have a plurality of scallops 102 each extending between the first lateral wall 90 and the second lateral wall 92 of the valve cover 86. Additionally, as is most clearly shown in FIGS. 1 and 5, the outer surface 28 of the cylinder head 12 may have a plurality of recesses 104 which is each aligned with a respective one of the bolt holes 52 in the cylinder head 12 to facilitate the head bolts 54 to be angled in the cylinder head 12. Furthermore, as is most clearly shown in FIGS. 1 and 5, a front wall 106 and a back wall 108 of the valve cover 86 may each have a plurality of recesses 110 that are aligned with a respective one of the bolt openings 96 in the valve cover 86 to facilitate the cam shaft 68 bolts to be angled in the respective bolt opening 96 in the valve cover 86.

In use, the cylinder head 12 is mounted to the internal combustion engine 14 and the cam shaft 68 drives each of the exhaust valve 56 and the pair of intake valves 61. The pair of intake valves 61 facilitates increased delivery of air-fuel mixture to the internal combustion engine 14 compared to traditional cylinder heads which employ a single intake valve. The dual intake valves 61 eliminate the need for the intake lobes 70 on the cam shaft 68 to be designed with high degrees of duration or lift as is commonly required with high performance engines associated with competitive racing. In this way the internal combustion engine 14 can operate in a manner that is compatible with day to day driving that is typically not practical with cam shafts which have high degrees of lift and duration. Thus, the internal combustion engine 14 can perform efficiently in both normal driving conditions and high performance driving conditions.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A three valve cylinder head assembly for facilitating two intake valves and one exhaust valve to be operated with a single overhead cam, said assembly comprising:
a cylinder head being mountable to an internal combustion engine, said cylinder head having a combustion chamber having a sloped roof such that said combustion chamber has a wedge shape, said cylinder head having an exhaust port and a pair of intake ports;
an exhaust valve being movably integrated into said cylinder head for opening and closing said exhaust port, said exhaust valve being positionable between an open position and a closed position;
a pair of intake valves, each of said intake valves being movably integrated into said cylinder head for opening and closing a respective one of said intake ports, each of said intake valves being positionable between an open position and a closed position;
wherein said closed position of said exhaust valve and said closed positions of said intake valves are coplanar;
a cam shaft being rotatably disposed on said cylinder head, said cam shaft engaging said exhaust valve and each of said intake valves, said cam shaft sequentially opening said exhaust valve and each of said intake valves as said cam shaft rotates for supporting operation of the internal combustion engine;
a valve cover being removably attached to said cylinder head such that said valve cover surrounds said cam shaft;
a pulley being attached to a respective end of said cam shaft thereby facilitating a belt to extend around said pulley for rotating said cam shaft
wherein said cylinder head has a bottom surface, a top surface and an outer surface extending between said top surface and said bottom surface, a front side of said outer surface having a planar lower portion forming an angle with a planar upper portion, said lower portion intersecting said bottom surface, said upper portion intersecting said top surface, said lower portion lying on a plane being parallel with a rear side of said outer surface, said upper portion lying on a plane angling toward said rear side between said lower portion and said top surface, said front side having a height being greater than a height of said rear side such that said top surface lies on a plane angling downwardly between said front side and said rear side; and
said combustion chamber extends from said bottom surface toward said top surface, said sloped roof of said combustion chamber sloping toward said top surface along an axis extending between said rear side and said front side of said outer surface of said cylinder head, said combustion chamber being centrally positioned on said bottom surface, said combustion chamber having a bounding edge intersecting said bottom surface, said bounding edge having a forward side, a rearward side, a first lateral side and a second lateral side, said forward side curving toward said front side of said outer surface of said cylinder head, said rearward side curving toward said rear side of said outer surface of said cylinder head.

2. (canceled)

3. The assembly according to claim 1, wherein:
each of said intake ports extends through said rear side of said outer surface and through said roof of said combustion chamber wherein each of said intake ports is configured to direct an air-fuel mixture into said combustion chamber; and
said exhaust port extends through said front side of said outer surface and through said roof of said combustion chamber wherein said exhaust port is configured to direct exhaust gases outwardly from said combustion chamber.

4. The assembly according to claim 1, wherein:
said cylinder head has a spark plug opening extending through said lower portion of said front side of said outer surface of said cylinder head and into said combustion chamber thereby facilitating a spark plug to be threaded into said spark plug opening; and
said cylinder head has a plurality of bolt holes each extending through said top surface and said bottom surface thereby facilitating head bolts to be extended through each of said bolt holes for attaching said cylinder head to the internal combustion engine.

5. The assembly according to claim 3, wherein said exhaust valve has a head and a stem, said stem extending through said cylinder head such that an end of said stem is spaced from said top surface of said cylinder head, said head being aligned with said exhaust port in said combustion chamber, said head resting against said sloped roof of said combustion chamber when said exhaust valve is in said closed position for closing said exhaust port, said head being spaced from said sloped roof when said exhaust valve is in said open position for opening said exhaust port.

6. The assembly according to claim 3, wherein each of said intake valves has a head and a stem, said stem of each of said intake valves extending through said cylinder head such that an end of said stem of each of said intake valves is spaced from said top surface of said cylinder head, said head of each of said intake valves being aligned with a respective one of said intake ports in said combustion chamber, said head of each of said intake ports resting against said sloped roof of said combustion chamber when said intake valves are in said closed position for closing said intake ports, said head of each of said intake valves being spaced from said sloped roof when said intake valves are in said open position for opening said intake ports.

7. The assembly according to claim 4, wherein:
said cam shaft has a pair of intake lobes and an exhaust lobe being positioned between said intake lobes, said exhaust lobe being offset a predetermined angle of rotation with said pair of intake lobes; and
a pair of risers, each of said risers being removably attached to said top surface of said cylinder head, each of said risers having an upper end which receives said cam shaft such that said cam shaft is spaced from said top surface.

8. The assembly according to claim 7, further comprising a plurality of lifters, each of said lifters having an upper end and a lower end, said lower end of each of said lifters having a well extending toward said upper end, said well in said lower end of each of said lifters insertably receiving an end of a stem of a respective one of said intake valves and said exhaust valve, said upper end of each of said lifters engaging a respective one of said intake lobes and said exhaust lobe on said cam shaft, each of said lifters being individually urged downwardly when said respective intake lobe and exhaust lobe is directed downwardly when said cam shaft rotates, each of said lifters being biased upwardly when said respective intake lobe and exhaust lobe is directed upwardly when said cam shaft rotates.

9. The assembly according to claim 7, wherein said valve cover has a topmost wall, a first lateral wall and a second lateral wall, said valve cover having a pair of camshaft openings each extending through a respective one of said first lateral wall and said second lateral wall thereby facilitating said cam shaft to be installed or removed through said camshaft openings, said valve cover having a plurality of bolt openings each extending through said valve cover, each of said bolt openings in said valve cover being aligned with a respective one of said risers thereby facilitating cam shaft bolts to be extended through a respective one of said bolt openings in said valve cover to attach said risers to said cylinder head.

10. A three valve cylinder head assembly for facilitating two intake valves and one exhaust valve to be operated with a single overhead cam, said assembly comprising:
a cylinder head being mountable to an internal combustion engine, said cylinder head having a combustion chamber having a sloped roof such that said combustion chamber has a wedge shape, said cylinder head having an exhaust port and a pair of intake ports, said cylinder head having a bottom surface, a top surface and an outer surface extending between said top surface and said bottom surface, a front side of said outer surface having a planar lower portion forming an angle with a planar upper portion, said lower portion intersecting said bottom surface, said upper portion intersecting said top surface, said lower portion lying on a plane being parallel with a rear side of said outer surface, said upper portion lying on a plane angling toward said rear side between said lower portion and said top surface, said front side having a height being greater than a height of said rear side such that said top surface lies on a plane angling downwardly between said front side and said rear side, said combustion chamber extending from said bottom surface toward said top surface, said sloped roof of said combustion chamber sloping toward said top surface along an axis extending between said rear side and said front side of said outer surface of said cylinder head, said combustion chamber being centrally positioned on said bottom surface, said combustion chamber having a bounding edge intersecting said bottom surface, said bounding edge having a forward side, a rearward side, a first lateral side and a second lateral side, said forward side curving toward said front side of said outer surface of said cylinder head, said rearward side curving toward said rear side of said outer surface of said cylinder head, each of said intake ports extending through said rear side of said outer surface and through said roof of said combustion chamber wherein each of said intake ports is configured to direct an air-fuel mixture into said combustion chamber, said exhaust port extending through said front side of said outer surface and through said roof of said combustion chamber wherein said exhaust port is configured to direct exhaust gases outwardly from said combustion chamber, said cylinder head having a spark plug opening extending through said lower portion of said front side of said outer surface of said cylinder head and into said combustion chamber thereby facilitating a spark plug to be threaded into said spark plug opening, said cylinder head having a plurality of bolt holes each extending through said top surface and said bottom surface thereby facilitating head bolts to be extended through each of said bolt holes for attaching said cylinder head to the internal combustion engine;
an exhaust valve being movably integrated into said cylinder head for opening and closing said exhaust port, said exhaust valve being positionable between an open position and a closed position, said exhaust valve having a head and a stem, said stem extending through said cylinder head such that an end of said stem is spaced from said top surface of said cylinder head, said head being aligned with said exhaust port in said combustion chamber, said head resting against said sloped roof of said combustion chamber when said exhaust valve is in said closed position for closing said exhaust port, said head being spaced from said sloped roof when said exhaust valve is in said open position for opening said exhaust port;
a pair of intake valves, each of said intake valves being movably integrated into said cylinder head for opening and closing a respective one of said intake ports, each of said intake valves being positionable between an open position and a closed position, each of said intake valves having a head and a stem, said stem of each of said intake valves extending through said cylinder head such that an end of said stem of each of said intake valves is spaced from said top surface of said cylinder head, said head of each of said intake valves being aligned with a respective one of said intake ports in said combustion chamber, said head of each of said intake ports resting against said sloped roof of said combustion chamber when said intake valves are in said closed position for closing said intake ports, said head of each of said intake valves being spaced from said sloped roof when said intake valves are in said open position for opening said intake ports;
wherein said closed position of said exhaust valve and said closed positions of said intake valves are coplanar;
a cam shaft being rotatably disposed on said cylinder head, said cam shaft engaging said exhaust valve and each of said intake valves, said cam shaft sequentially opening said exhaust valve and each of said intake valves as said cam shaft rotates for supporting operation of the internal combustion engine, said cam shaft having a pair of intake lobes and an exhaust lobe being positioned between said intake lobes, said exhaust lobe being offset a predetermined angle of rotation with said pair of intake lobes;
a pair of risers, each of said risers being removably attached to said top surface of said cylinder head, each of said risers having an upper end which receives said cam shaft such that said cam shaft is spaced from said top surface;
a plurality of lifters, each of said lifters having an upper end and a lower end, said lower end of each of said lifters having a well extending toward said upper end, said well in said lower end of each of said lifters insertably receiving said end of said stem of a respective one of said intake valves and said exhaust valve, said upper end of each of said lifters engaging a respective one of said intake lobes and said exhaust lobe on said cam shaft, each of said lifters being individually urged downwardly when said respective intake lobe and exhaust lobe is directed downwardly when said cam shaft rotates, each of said lifters being biased upwardly when said respective intake lobe and exhaust lobe is directed upwardly when said cam shaft rotates;
a valve cover being removably attached to said cylinder head such that said valve cover surrounds said cam shaft, said valve cover having a topmost wall, a first lateral wall and a second lateral wall, said valve cover having a pair of camshaft openings each extending through a respective one of said first lateral wall and said second lateral wall thereby facilitating said cam shaft to be installed or removed through said camshaft openings, said valve cover having a plurality of bolt openings each extending through said valve cover, each of said bolt openings in said valve cover being aligned with a respective one of said risers thereby facilitating cam shaft bolts to be extended through a respective one of said bolt openings in said valve cover to attach said risers to said cylinder head; and
a pulley being attached to a respective end of said cam shaft thereby facilitating a belt to extend around said pulley for rotating said cam shaft.
